(19) United States
(12) Patent Application Publication
(10) Pub. No.: US 2004/0097692 A1
(43) Pub. Date: May 20, 2004

(54) Method of producing polyamides

(76) Inventors: Helmut Winterling, Ludwigshafen (DE); Gerd Blinne, Bobenheim (DE); Gunter Vogel, Speyer (DE)

Correspondence Address: KEIL & WEINKAUF, 1350 CONNECTICUT AVENUE, N.W., WASHINGTON, DC, 20036, US

(21) Appl. No.: 10/472,147

(22) PCT Filed: Mar. 20, 2002
(86) PCT No.: PCT/EP02/03278

(30) Foreign Application Priority Data
Mar. 23, 2001 (DE) 101 14 690.6

(51) Int. Cl. C08G 69/00

(52) U.S. Cl. 528/310

(57) ABSTRACT

A process is provided for the preparation of polyamides in an aqueous reaction mixture containing a nitrile selected from 6-aminocapronitrile and adipodinitrile, wherein a nitrile is used through which, in the liquid state, a gas inert to the nitrile has been passed.

The present invention relates to a process for the preparation of polyamides in an aqueous reaction mixture containing a nitrile selected from 6-aminocapronitrile and adipodinitrile, wherein a nitrile is used through which, in the liquid state, a gas inert to the nitrile has been passed, and to polyamides obtainable by such a process.

Processes for the preparation of polyamides in an aqueous reaction mixture containing a nitrile selected from 6-aminocapronitrile and adipodinitrile are generally known.

Thus, for example, U.S. Pat. No. 2,245,129 describes the preparation of polyamides from an aminonitrile. According to Example 1, polycaprolactam (polyamide 6, nylon 6) is obtained by the conversion of 6-aminocapronitrile. According to Example 2, polyhexamethyleneadipamide (polyamide 6,6, nylon 6,6) is obtained by reacting adipodinitrile and hexamethylenediamine.

On page 3, lines 44-50, it is recommended that the second or last polymerization step, which follows the first step for the formation of precursors, be carried out under an inert gas in order to avoid a discoloration of the polyamide.

U.S. Pat. No. 4,436,898 describes (column 4, lines 4-8) that, in the preparation of polyamide from adipodinitrile, hexamethylenediamine and water, 2-cyanocyclopentylimine can be formed intramolecularly from the adipodinitrile, causing gelling and discoloration. Likewise, in the preparation of polyamide from 6-aminocapronitrile, imino functional groups can be formed intramolecularly by a Thorpe reaction, as described for example in Jerry March, Advanced Organic Chemistry, 3rd edition, John Wiley & Sons, New York, 1985, page 854, from which rings can be formed by an intramolecular reaction with an amino group, or keto groups can be formed by hydrolysis, again causing discolorations.

According to U.S. Pat. No. 4,568,736, thermally stable polyamides can be obtained from 6-aminocapronitrile and water by using certain catalysts in the polymerization.

Thus, in the preparation of polyamides from aqueous reaction mixtures containing 6-aminocapronitrile or adipodinitrile, cyclic compounds can be formed intramolecularly from 6-aminocapronitrile or adipodinitrile, causing an unwanted discoloration of the polyamide.

WO 00/24808 discloses (page 15, lines 19-21) that polyamides which have been prepared using 6-aminocapronitrile contain extractable constituents such as caprolactam or low-molecular oligomers. According to Kirk-Othmer, Encyclopedia of Chemical Technology, 4th edition, vol. 19, John Wiley & Sons, New York, 1996, pages 493-495, this monomer and oligomer content degrades the quality of the polyamide and must therefore be reduced. This reduction is conventionally carried out industrially by extraction with hot water under superatmospheric pressure.

This extraction of polyamides which have been prepared using 6-aminocapronitrile can be accompanied by an increase in discoloration.

It is an object of the present invention to provide a process for the preparation of polyamides from aqueous reaction mixtures containing a nitrile selected from 6-aminocapronitrile and adipodinitrile, which process, in a technically simple and economic manner, yields a less discolored polyamide after polymerization and additionally, in the case of aqueous reaction mixtures containing 6-aminocapronitrile, yields a polyamide whose discoloration does not increase on extraction, and to provide polyamides obtainable by such a process.

We have found that this object is achieved by the process defined at the outset.

The nitrile used according to the invention is selected from 6-aminocapronitrile and adipodinitrile.

6-Aminocapronitrile and adipodinitrile, and processes for their preparation, are known per se, for example from the state of the art acknowledged at the outset.

In one advantageous embodiment, it is possible to use the molten nitrile in pure form.

In this case the lower temperature is determined by the melting point of the nitrile (melting point of 6-aminocapronitrile: −34° C.; melting point of adipodinitrile: +1° C.). An appropriate temperature is preferably at least 5° C. and especially at least 20° C. above the melting point.

In the case of the pure nitrile, the upper temperature is determined by the decomposition of the nitrile and the vapor pressure at the particular temperature; as the temperature increases, larger amounts of nitrile are entrained with the gas passing through it. An appropriate temperature is advantageously at most 50° C. and especially at most 30° C.

In another advantageous embodiment, it is possible to use the nitrile together with a liquid diluent.

Appropriate liquid diluents are inorganic compounds such as water, or organic compounds such as C₁-C₄-alkanols, for example methanol, ethanol, n-propanol, i-propanol, n-butanol, i-butanol and s-butanol, ethers, for example dioxane, aromatics, for example toluene, o-xylene, m-xylene and p-xylene, or mixtures thereof such as water/C₁-C₄-alkanol mixtures, for example water/ethanol mixtures; water is preferred.

In this case the lower temperature is determined by the melting point of the mixture. An appropriate temperature is preferably at least 10° C. and especially at least 20° C. above the melting point of the mixture.

In the case of the mixture, the upper temperature is determined by the decomposition of the mixture and the vapor pressure at the particular temperature; as the temperature increases, larger amounts of mixture are entrained with the gas passing through it. An appropriate temperature is advantageously at most 50° C. and especially at most 30° C.

The lower pressure should at least correspond to the vapor pressure of the pure nitrile or the mixture at the chosen temperature.

If the reaction is carried out at a lower pressure, a substantial amount of the nitrile or mixture is entrained with the gas passing through it. The pressure should advantageously be 0.1 kPa and especially 1 kPa above the vapor pressure at the chosen temperature.

In principle, the pressure has no set upper limit as stated above, but it has been shown that, above a pressure of 300 kPa and especially 200 kPa, increasing the pressure brings no further advantages to the process according to the invention, whereas the technical cost of controlling the pressure increases markedly.

According to the invention, a gas inert to the nitrile is passed through said nitrile.

In terms of the present invention, inert gases are regarded as being gases which do not cause any chemical changes in the nitrile through which they are to be passed, due to a reaction between nitrile and gas.

For technical reasons, such gases can contain impurities which are not inert to the nitrile. It is self-evident that the advantageous effect of the process according to the invention is all the more pronounced, the lower the content of such impurities in the inert gas.

Inert gases which can advantageously be used are nitrogen, argon, helium, neon or mixtures thereof, preferably nitrogen, helium, argon or mixtures thereof and especially nitrogen, argon or mixtures thereof.

In one advantageous embodiment, the inert gas can be passed through the nitrile at a rate ranging from 0.01 to 100, preferably from 0.1 to 40 and especially from 1 to 15 m³ gas/hour/m³ nitrile.

If the chosen amounts are smaller than those according to the advantageous embodiment, previous observations have shown that the advantageous effect of the process according to the invention can generally be enhanced by increasing the amount.

If the amounts according to the advantageous embodiment are exceeded, no substantial enhancement of the advantage achievable with the process according to the invention has been observed hitherto. In addition, when the amounts are unduly large, there is an increase in the technical cost of separating the nitrile from the inert gas after the latter has been passed through the nitrile.

In one advantageous embodiment, the inert gas can be passed through the nitrile for a period ranging from 1 to 200, preferably from 5 to 150 and especially from 10 to 80 minutes.

If the passage of gas is interrupted, said ranges are understood as meaning the sum of the individual periods.

A longer time is not critical per se. Thus, after the process according to the invention, the nitrile can be stored for weeks without losing the advantage according to the invention.

It is also possible to choose shorter periods than those corresponding to the advantageous embodiment. Previous observations have shown that, in such a case, an additional advantageous effect can be achieved by further application of the process according to the invention.

The passage of the inert gas through the nitrile can be carried out in reactors known per se for reacting gases with liquids, for example tanks, stirred tanks, loop reactors, tubular reactors, bubble columns, reaction columns, thin film reactors and gas-liquid bioreactors, with the facilities known for such reactors for introducing gases into liquids, including simple dipping means, i.e. inlet tubes, or filter cartridges, such as those known for example from Ullmann's Encyclopedia of Industrial Chemistry, 5th ed., vol. B4, VCH Verlagsgesellschaft mbH, Weinheim, 1992, pp. 167-337 and pp. 381-433, or Ullmann's Encyclopedia of Industrial Chemistry, 5th ed., vol. B2, VCH Verlagsgesellschaft mbH, Weinheim, 1988, pp. 25-31.

If the inert gas contains droplets of nitrile after it has been passed through the nitrile, these droplets can be separated from the inert gas by means of devices known per se, for example by means of droplet separators, felt filters, spiral bed filters, fixed bed filters, fluidized bed filters, cyclones, electrical deposition and scrubbers, such as those described for example in Ullmann's Encyclopedia of Industrial Chemistry, 5th ed., vol. B2, VCH Verlagsgesellschaft mbH, Weinheim, 1988, pp. 13-15 - 13-25, or for example by means of the devices known for reacting gases with liquids, for example from Ullmann's Encyclopedia of Industrial Chemistry, 5th ed., vol. B4, VCH Verlagsgesellschaft mbH, Weinheim, 1992, pp. 167-337 and pp. 381-433, or Ullmann's Encyclopedia of Industrial Chemistry, 5th ed., vol. B2, VCH Verlagsgesellschaft mbH, Weinheim, 1988, pp. 25-21 - 25-31.

In one advantageous embodiment, tanks are used as the reactor and the inert gas is introduced by means of an inlet tube.

The nitrile obtainable by the process according to the invention can be used in the form of an aqueous reaction mixture for the preparation of polyamides by processes known per se, the nitrile used in the known processes being replaced with the nitrile obtained by the present process. Previous observations have shown that the parameters known for such processes can be taken over unchanged. An optionally advantageous adaptation of such processes to the nitrile obtainable by the present process can easily be determined by those skilled in the art by means of a few simple preliminary experiments.

Polyamides are understood as meaning homopolymers, copolymers, mixtures and grafts of synthetic long-chain polyamides of which the essential constituent consists of recurring amide groups in the polymer main chain. Examples of such polyamides are nylon 6 (polycaprolactam), nylon 6,6 (polyhexamethyleneadipamide) and nylon 4,6 (polytetramethyleneadipamide). It is known that these polyamides have the generic name nylon.

Such polyamides can advantageously be obtained by processes known per se from monomers selected from 6-aminocapronitrile, a preferably equimolar mixture of adipodinitriol [sic] and hexamethylenediamine, or mixtures thereof.

In another advantageous embodiment, it is possible to use a monomer selected from 6-aminocapronitrile, a preferably equimolar mixture of adipodinitriol [sic] and hexamethylenediamine, or mixtures thereof, together with other monomers capable of forming polyamides, such as lactams, omega-aminocarboxylic acids, omega-aminocarbonitriles, omega-aminocarboxamides, omega-aminocarboxylic acid salt [sic], omega-aminocarboxylic acid ester [sic], equimolar mixtures of diamines and dicarboxylic acids, dicarboxylic acid/diamine salts, dinitriles and diamines, or mixtures of such monomers.

Other suitable monomers capable of forming polyamides are

monomers or oligomers of a C₂ to C₂₀ and preferably C₂ to C₁₈ arylaliphatic or, preferably, aliphatic lactam such as enantholactam, undecanolactam, dodecanolactam or caprolactam,

monomers or oligomers of C₂ to C₂₀ and preferably C₃ to C₁₈ aminocarboxylic acids such as 6-aminocaproic acid and 11-aminoundecanoic acid, their dimers, trimers, tetramers, pentamers or hexamers, and their salts such as alkali metal salts, for example lithium, sodium and potassium salts,

C₂ to C₂₀ and preferably C₃ to C₁₈ aminocarbonitriles such as 11-aminoundecanonitrile,

monomers or oligomers of C₂ to C₂₀ amino acid amides such as 6-aminocaproamide and 11-aminoundecanoamide, and their dimers, trimers, tetramers, pentamers or hexamers,

esters, preferably C₁-C₄-alkyl esters, such as methyl, ethyl, n-propyl, i-propyl, n-butyl, i-butyl and s-butyl esters, of C₂ to C₂₀ and preferably C₃ to C₁₈ aminocarboxylic acids, such as 6-aminocaproic acid esters, for example methyl 6-aminocaproate, and 11-aminoundecanoic acid esters, for example methyl 11-aminoundecanoate,

monomers or oligomers of a C₂- to C₂₀- and preferably C₂- to C₁₂-alkyldiamine [sic], such as tetramethylenediamine or, preferably, hexamethylenediamine,

with a C₂ to C₂₀ and preferably C₂ to C₁₄ aliphatic dicarboxylic acid or its mono- or dinitriles, such as sebacic acid, dodecanedioic acid, adipic acid, sebacic acid dinitrile or decanoic acid dinitrile,

and their dimers, trimers, tetramers, pentamers or hexamers,

monomers or oligomers of a C₂- to C₂₀- and preferably C₂- to C₁₂-alkyldiamine [sic], such as tetramethylenediamine or, preferably, hexamethylenediamine,

with a C₈ to C₂₀ and preferably C₈ to C₁₂ aromatic dicarboxylic acid or its derivatives, for example chlorides, such as 2,6-naphthalenedicarboxylic acid or, preferably, isophthalic acid or terephthalic acid,

and their dimers, trimers, tetramers, pentamers or hexamers,

monomers or oligomers of a C₂- to C₂₀- and preferably C₂- to C₁₂-alkyldiamine [sic], such as tetramethylenediamine or, preferably, hexamethylenediamine,

with a C₉ to C₂₀ and preferably C₉ to C₁₈ arylaliphatic dicarboxylic acid or its derivatives, for example chlorides, such as o-, m- or p-phenylenediacetic acid,

and their dimers, trimers, tetramers, pentamers or hexamers,

monomers or oligomers of a C₆ to C₂₀ and preferably C₆ to C₁₀ aromatic diamine, such as m- or p-phenylenediamine,

with a C₂ to C₂₀ and preferably C₂ to C₁₄ aliphatic dicarboxylic acid or its mono- or dinitriles, such as sebacic acid, dodecanedioic acid, adipic acid, sebacic acid dinitrile or decanoic acid dinitrile,

monomers or oligomers of a C₆ to C₂₀ and preferably C₆ to C₁₀ aromatic diamine, such as m- or p-phenylenediamine,

with a C₈ to C₂₀ and preferably C₈ to C₁₂ aromatic dicarboxylic acid or its derivatives, for example chlorides, such as 2,6-naphthalenedicarboxylic acid or, preferably, isophthalic acid or terephthalic acid,

and their dimers, trimers, tetramers, pentamers or hexamers,

monomers or oligomers of a C₆ to C₂₀ and preferably C₆ to C₁₀ aromatic diamine, such as m- or p-phenylenediamine,

with a C₉ to C₂₀ and preferably C₉ to C₁₈ arylaliphatic dicarboxylic acid or its derivatives, for example chlorides, such as o-, m- or p-phenylenediacetic acid,

and their dimers, trimers, tetramers, pentamers or hexamers,

monomers or oligomers of a C₇ to C₂₀ and preferably C₈ to C₁₈ arylaliphatic diamine, such as m- or p-xylylenediamine,

with a C₂ to C₂₀ and preferably C₂ to C₁₄ aliphatic dicarboxylic acid or its mono- or dinitriles, such as sebacic acid, dodecanedioic acid, adipic acid, sebacic acid dinitrile or decanoic acid dinitrile,

and their dimers, trimers, tetramers, pentamers or hexamers,

monomers or oligomers of a C₇ to C₂₀ and preferably C₈ to C₁₈ arylaliphatic diamine, such as m- or p-xylylenediamine,

with a C₆ to C₂₀ and preferably C₆ to C₁₀ aromatic dicarboxylic acid or its derivatives, for example chlorides, such as 2,6-naphthalenedicarboxylic acid or, preferably, isophthalic acid or terephthalic acid,

and their dimers, trimers, tetramers, pentamers or hexamers,

monomers or oligomers of a C₇ to C₂₀ and preferably C₈ to C₁₈ arylaliphatic diamine, such as m- or p-xylylenediamine,

with a C₉ to C₂₀ and preferably C₉ to C₁₈ arylaliphatic dicarboxylic acid or its derivatives, for example chlorides, such as o-, m- or p-phenylenediacetic acid,

and their dimers, trimers, tetramers, pentamers or hexamers,

and homopolymers, copolymers, mixtures and grafts of such starting monomers or starting oligomers.

In one preferred embodiment, in addition to a monomer selected from 6-aminocapronitrile, a preferably equimolar mixture of adipodinitriol [sic] and hexamethylenediamine, or mixtures thereof, it is possible to use caprolactam as a lactam, tetramethylenediamine, hexamethylenediamine or mixtures thereof as a diamine, and adipic acid, sebacic acid, dodecanedioic acid, terephthalic acid, isophthalic acid or mixtures thereof as a dicarboxylic acid, particularly preferably caprolactam as a lactam, hexamethylenediamine as a diamine and adipic acid, terephthalic acid or mixtures thereof as a dicarboxylic acid.

Particularly preferred starting monomers or starting oligomers are those which polymerize to the polyamides nylon 6, nylon 6,6 or nylon 4,6, especially nylon 6 or nylon 6,6.

In one preferred embodiment, one or more chain regulators can be used in the preparation of the polyamides. Suitable chain regulators are advantageously compounds which contain one or more, such as two, amino groups reactive in the formation of polyamides, or one or more, such as two, carboxyl groups reactive in the formation of polyamides.

Chain regulators which can advantageously be used are monocarboxylic acids such as alkanecarboxylic acids, for example acetic acid or proprionic [sic] acid, and benzene- or naphthalenemonocarboxylic acid, for example benzoic acid, dicarboxylic acids such as C₄-C₁₀-alkanedicarboxylic acid [sic], for example adipic acid, azelaic acid, sebacic acid or dodecanedioic acid, C₅-C₈-cycloalkanedicarboxylic acids, for example cyclohexane-1,4-dicarboxylic acid, and benzene- or naphthalenedicarboxylic acid [sic], for example terephthalic acid, isophthalic acid or naphthalene-2,6-dicarboxylic acid, C₂- to C₂₀- and preferably C₂- to C₁₂-alkylamines such as cyclohexylamine, C₆ to C₂₀ and preferably C₆ to C₁₀ aromatic monoamines such as aniline, or C₇ to C₂₀ and preferably C₈ to C₁₈ arylaliphatic monoamines such as benzylamine, and diamines such as C₄-C₁₀-alkanediamines, for example hexamethylenediamine.

A chain regulator can advantageously be used in amounts of at least 0.01 mol %, preferably of at least 0.05 mol % and especially of at least 0.2 mol %, based on 1 mole of acid amide groups in the polyamide.

A chain regulator can advantageously be used in amounts of at most 1.0 mol %, preferably of at most 0.6 mol % and especially of at most 0.5 mol %, based on 1 mole of acid amide groups in the polyamide.

In another preferred embodiment, the polymerization or polycondensation by the process according to the invention is carried out in the presence of at least one pigment. Preferred pigments are titanium dioxide—which can be in the form of the anatase modification, the rutile modification or mixtures of the anatase and rutile modifications—or color-causing compounds of an inorganic or organic nature. The pigments are preferably added in an amount of 0 to 5 parts by weight and especially of 0.02 to 2 parts by weight, based in each case on 100 parts by weight of polyamide. The pigments can be introduced into the reactor together with the starting materials or separately therefrom.

Processes for the preparation of polyamides in an aqueous reaction mixture containing a nitrile selected from 6-aminocapronitrile and adipodinitrile, and optionally additives conventional per se, such as inorganic or organic pigments, and homogeneous or heterogeneous catalysts such as phosphorous acid, hypophosphorous acid or phosphoric acid as well as their alkali metal, alkaline earth metal or ammonium salts, such Na₃PO₄, Na₂HPO₄, NaH₂PO₄, Na₂HPO₃, NaH₂PO₃, K₃PO₄, K₂HPO₄, KH₂PO₄ and KH₂PO₃, and alkyl- or aryl-substituted phosphorus-oxygen compounds such as alkyl- or aryl-substituted phosphonic acids of the formula RPO(OH)₂, where R is an alkyl or aryl radical, are known per se and are in [sic] described for example in U.S. Pat. No. 2,245,129, U.S. Pat. No. 4,436,898, U.S. Pat. No. 4,568,736 and WO 00/24808.

The extraction which is advantageous in the case of polyamides prepared using 6-aminocapronitrile can be effected by processes known per se, the polyamide used in the known processes being replaced with the polyamide obtained by the present process. Previous observations have shown that the parameters known for such processes can be taken over unchanged. A possibly advantageous adaptation of such processes to the polyamide obtainable by the present process can easily be determined by those skilled in the art by means of a few simple preliminary experiments.

Processes for the extraction of polyamides prepared using 6-aminocapronitrile are described for example in Kirk-Othmer, Encyclopedia of Chemical Technology, 4th edition, vol. 19, John Wiley & Sons, New York, 1996, pages 493-495.

The polyamides obtainable by the process according to the invention can be processed by the methods conventionally used for polyamides to produce geometric entities such as filaments, fibers, fabrics and moldings, the lower discoloring tendency of the polyamides according to the invention again being an advantage here.

In terms of the present invention, the discoloration is defined by the APHA number. The APHA number is determined, in the manner described in the Examples, as the difference in the extinction of a formic acid solution of the polyamide at 470 nm and at 600 nm. The lower the APHA number, the less is the discoloration of the polyamide.

Polyamides obtainable by the process according to the invention which are substantially based on adipodinitrile and hexamethylenediamine preferably have an APHA number of less than 15 and especially of less than 5.

Polyamides obtainable by the process according to the invention which are substantially based on 6-aminocapronitrile preferably have an APHA number of less than 15 and especially of less than 5.

### EXAMPLES

### Determination of the APHA Number

### a) Determination of the Calibration Factor f

0.249 g of potassium hexachloroplatinate(IV) and 0.2 g of cobalt(II) chloride hexahydrate are dissolved in 500 ml of distilled water in a 1000 ml volumetric flask, 20 ml of hydrochloric acid of density 1.18 g/cm³ are added and the volume is made up to the mark with distilled water.

The extinction E₀ of this solution is measured in 5 cm cuvettes at a wavelength of 470 nm against distilled water. The calibration factor f is then calculated from f=100/E₀.

### b) Preparation of the Polyamide Solution

7 g of polyamide are dissolved in 100 ml of formic acid over 16 hours at room temperature in a 200 ml conical flask. The solution is then centrifuged at 35,000 G.

### c) Measurement of the Color Number

The extinction E of the polyamide solution is measured in a 5 cm cuvette at a wavelength of 470 nm (E₄₇₀) and 600 nm (E₆₀₀) against formic acid.

The APHA number (in Pt—Co units) is then determined from:

APHA number=f * (E₄₇₀-E₆₀₀)

### Preparation of the Polyamides

The polyamides were prepared with a mixture of 6-aminocapronitrile (6-ACN) and deionized water. The 6-aminocapronitrile/water mixture was stored in a 2 l formulating tank provided with a lance suitable for the introduction of gas, and fed by means of a piston pump into an apparatus as shown in FIG. 1 of DE-A-19804023.

The first process stage (1), with an empty volume of 1 liter and an internal length of 1000 mm, was filled with chopped strands of titanium dioxide which had been prepared as described in Ert1, Köbzinger, Weitkamp: “Handbook of heterogeneous catalysis”, VCH Weinheim, 1997, page 98 et seq. 100% of the chopped strands consisted of TiO₂ in the so-called anatase modification and the strands had a length of between 2 and 14 mm, a thickness of ca. 2 mm and a specific surface area of 110 m²/g.

A separating tank with a capacity of 2 liters was used as the second stage (2).

The third stage (3), with an empty volume of 1 liter and an internal length of 1000 mm, was filled with the chopped strands of titanium dioxide described under process stage (1). In this tubular reactor the reaction mixture could be mixed with more water from a receiver (cf. said FIG. 1).

The fourth stage (4) again consisted of a separating tank (volume: 5 liters) from which the prepared polymer melt was withdrawn in the form of a strand by means of a gear pump (A).

### Example 1

A 6-aminocapronitrile/water mixture with the composition shown in Table 1 was stored under nitrogen for two hours in the formulating tank and nitrogen was passed through the mixture for two hours via the lance.

The throughput T shown in Table 1 is the mass flux of the reaction mixture from the formulating tank through the first process stage. The water throughput WT into the third process stage is based on the throughput of the reaction mixture into the first process stage and is given in percent. The pressures and temperatures in the four stages are collated in Table 1.

The polyamide obtained from the fourth stage was dried in a vacuum drying cabinet for 24 hours at 70° C. under 3 kPa.

The APHA number was determined as 3.

### Example 2

The procedure was as in Example 1 except that the polyamide was extracted by refluxing 100 parts by weight of polyamide in 400 parts by weight of deionized water at a temperature of 100° C. for 32 hours under a nitrogen blanket, the water was removed and the polyamide was dried under mild conditions and then in a vacuum drying cabinet for 24 hours at 70° C. under 3 kPa.

The APHA number was determined as 3.

### Comparative Example 1

The procedure was as in Example 1 except that nitrogen was not passed through the 6-aminocapronitrile/water mixture.

The APHA number was determined as 21.

### Comparative Example 2

The procedure was as in Example 2 except that nitrogen was not passed through the 6-aminocapronitrile/water mixture.

The APHA number was determined as 37.

TABLE 1

| | | | Comp. | Comp. |
|---|---|---|---|---|
| | Ex. 1 | Ex. 2 | Ex. 1 | Ex. 2 |
| 6-ACN: water [mol:mol] | 1:6 | 1:6 | 1:6 | 1:6 |
| Nitrogen flow rate | 2 | 2 | None | None |
| [m³ nitrogen/hour/m³ 6-ACN] | | | | |
| T [kg/h] | 0.6 | 0.6 | 0.6 | 0.6 |
| 1st stage: T [° C.] | 230 | 230 | 230 | 230 |
| 1st stage: p [MPa] | 8.6 | 8.6 | 8.6 | 8.6 |
| 2nd stage: T [° C.] | 258 | 258 | 258 | 258 |
| 2nd stage: p [MPa] | 3.0 | 3.0 | 3.0 | 3.0 |
| 3rd stage: T [° C.] | 240 | 240 | 240 | 240 |
| 3rd stage: p [MPa] | 5.6 | 5.6 | 5.6 | 5.6 |
| WT [%] | 10 | 10 | 10 | 10 |
| 4th stage: T [° C.] | 255 | 255 | 255 | 255 |
| 4th stage: p [MPa] | 0.1 | 0.1 | 0.1 | 0.1 |

We claim:

1. A process for the preparation of polyamides in an aqueous reaction mixture containing a nitrile selected from 6-aminocapronitrile and adipodinitrile, wherein a nitrile is used through which, in the liquid state, a gas inert to the nitrile has been passed.

2. A process as claimed in claim 1 wherein the inert gas used is nitrogen, argon, helium, neon or mixtures thereof.

3. A process as claimed in claim 1 wherein the inert gas used is nitrogen, argon or mixtures thereof.

4. A process as claimed in any of claims 1 to 3 wherein the inert gas is passed through the nitrile at a rate ranging from 0.01 to 100 m³ gas/hour/m³ nitrile.

5. A process as claimed in any of claims 1 to 4 wherein the inert gas is passed through the nitrile for a period ranging from 1 to 200 minutes.

6. A polyamide obtainable by a process as claimed in any of claims 1 to 5.
